(19) United States
(12) Patent Application Publication
(10) Pub. No.: US 2021/0183368 A1
(43) Pub. Date: Jun. 17, 2021

(54) LEARNING DATA GENERATION DEVICE, LEARNING DATA GENERATION METHOD, AND PROGRAM

(71) Applicant: NIPPON TELEGRAPH AND TELEPHONE CORPORATION, Chiyoda-ku, Tokyo (JP)

(72) Inventors: Ryo MASUMURA, Musashino-shi, Tokyo (JP); Tomohiro TANAKA, Musashino-shi, Tokyo (JP)

(73) Assignee: NIPPON TELEGRAPH AND TELEPHONE CORPORATION, Chiyoda-ku, Tokyo (JP)

(21) Appl. No.: 17/267,867

(22) PCT Filed: Jun. 21, 2019
(86) PCT No.: PCT/JP2019/024827

§ 371 Date: Feb. 11, 2021

(30) Foreign Application Priority Data
Aug. 15, 2018 (JP) 2018-152956

(51) Int. Cl. G10L 15/06; G10L 15/02; G10L 15/187; G10L 15/197

(52) U.S. Cl. CPC G10L 15/063; G10L 15/02; G10L 2015/025; G10L 15/197; G10L 15/187

(57) ABSTRACT

Learning data is generated automatically without manually applying rules. An acoustic model learning data generation device 20 includes a stochastic attribute label generation model 21 that generates attribute labels from a first model parameter group according to a first probability distribution; a stochastic phoneme sequence generation model 22 that generates a phoneme sequence from a second model parameter group and the attribute labels according to a second probability distribution; and a stochastic acoustic feature quantity sequence generation model 23 that generates an acoustic feature quantity sequence from a third model parameter group, the attribute labels, and the phoneme sequence according to a third probability distribution.

### TECHNICAL FIELD

The present invention relates to a learning data generation device, a learning data generation method, and a program for generating acoustic model learning data.

### BACKGROUND ART

Speech recognition has come to be used in various environments through smartphones, robots, and the like. For advanced speech recognition in such actual environments, it is required that an acoustic model is robust to various acoustic variations. Acoustic variations represent various variations in speech information resulting from noisy environment characteristics, microphone characteristics, speaker characteristics, and the like. To construct an acoustic model robust to these variations, it is effective to collect a large quantity of acoustic model learning data including these acoustic variation factors in actual environments and learn the acoustic model. The acoustic model learning data represents a data set including one or more pairs of an acoustic feature quantity sequence of speech and a corresponding phoneme sequence.

However, since the quantity of collectable learning data is often limited due to cost issues when constructing a speech recognition system actually, it is often difficult to learn an acoustic model sufficiently robust to various variation factors. As an approach for dealing with this problem, it is known that pseudo-generation of learning data is effective. For example, to make robust to noisy environment characteristics, learning data collected in a noisy environment can be pseudo-created by artificially adding noise to an acoustic feature quantity sequence of learning data collected in a quiet environment.

NPL 1 and NPL 2 disclose techniques of pseudo-adding acoustic variation factors to generate learning data. In these studies, acoustic variation factors are added to an acoustic feature quantity sequence of learning data according to rules manually modelled in advance to create an acoustic feature quantity sequence to which acoustic variation factors are pseudo-added, the acoustic feature quantity sequence is paired with a corresponding phoneme sequence to obtain pseudo-created learning data, which is used for learning an acoustic model.

### CITATION LIST

### Non Patent Literature

[NPL 1] N. Jaitly and G. E. Hinton, “Vocal tract length perturbation (VTLP) improves speech recognition,” In Proc. ICML. Workshop on Deep Learning for Audio, Speech and. Language, 2013.
[NPL 2] N. Kanda, R. Takeda, and Y. Obuchi, “Elastic spectral distortion for low resource speech recognition with deep neural networks,” In Proc. IEEE Automatic Speech Recognition and Understanding Workshop (ASRU), pp. 309-314, 2013.

### SUMMARY OF THE INVENTION

### Technical Problem

However, in the conventional method of pseudo-generating learning data, it is necessary to manually applying prescribed speech variation rules, and there is a problem that it is not possible to automatically generate learning data.

With the foregoing in view, an object of the present invention is to provide a learning data generation device, a learning data generation method, and a program capable of automatically generating learning data without manually applying rules.

### Means for Solving the Problem

In order to solve the problems, a learning data generation device according to the present invention is a learning data generation device that generates acoustic model learning data, including a stochastic attribute label generation model that generates attribute labels from a first model parameter group according to a first probability distribution; a stochastic phoneme sequence generation model that generates a phoneme sequence from a second model parameter group and the attribute labels according to a second probability distribution; and a stochastic acoustic feature quantity sequence generation model that generates an acoustic feature quantity sequence from a third model parameter group, the attribute labels, and the phoneme sequence according to a third probability distribution.

In order to solve the problems, a learning data generation method according to the present invention is a learning data generation method of generating acoustic model learning data, including generating attribute labels from a first model parameter group according to a first probability distribution; generating a phoneme sequence from a second model parameter group and the attribute labels according to a second probability distribution; and generating an acoustic feature quantity sequence from a third model parameter group, the attribute labels, and the phoneme sequence according to a third probability distribution.

In order to solve the problems, a program according to the present invention causes a computer to function as the learning data generation device.

### Effects of the Invention

According to the present invention, it is possible to provide a framework that automatically generates learning data without manually applying rules.

### BRIEF DESCRIPTION OF DRAWINGS

FIG. 1 is a block diagram illustrating a configuration example of a learning data generation system including a learning data generation device according to an embodiment of the present invention.

FIG. 2 is a block diagram illustrating a configuration example of a learning data generation device according to an embodiment of the present invention.

FIG. 3 is a block diagram illustrating a configuration example of a model parameter learning device that generates parameters to be input to a learning data generation device according to an embodiment of the present invention.

FIG. 4 is a flowchart illustrating an example of procedures of a laser emitting method according to an embodiment of the present invention.

### DESCRIPTION OF EMBODIMENTS

Hereinafter, an embodiment of the present invention will be described with reference to the drawings.

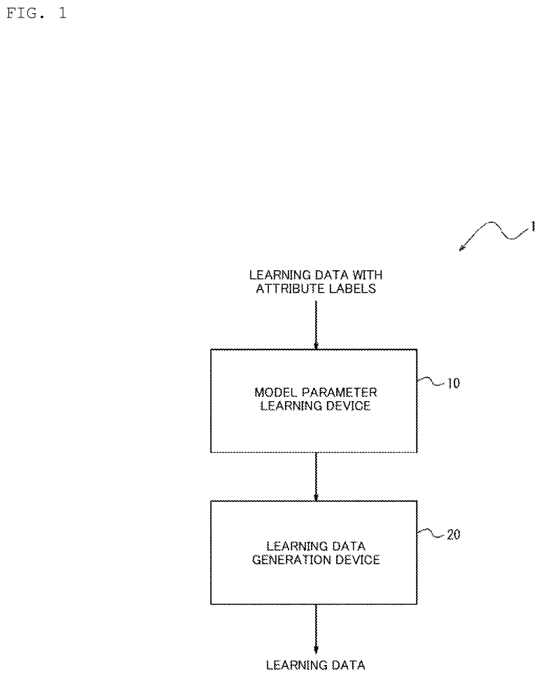

FIG. 1 is a block diagram illustrating a configuration example of a learning data generation system. 1 including a learning data generation device according to an embodiment of the present invention. The learning data generation system 1 includes a model parameter learning device 10 and a learning data generation device 20, and automatically generates new learning data not included in collected acoustic model learning data with attribute labels using the learning data with attribute labels. An acoustic model is a model that defines a probability that a phoneme sequence is output when a certain acoustic feature quantity sequence is input.

In the present embodiment, although the model parameter learning device 10 and the learning data generation device 20 are described separately, these devices may be formed integrally. Therefore, the learning data generation device 20 may include respective units of the model parameter learning device 10.

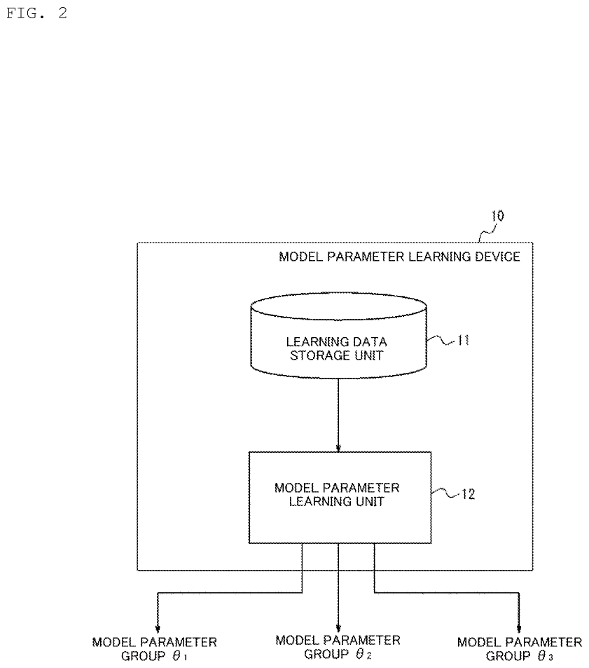

FIG. 2 is a block diagram illustrating a configuration example of the model parameter learning device 10. The model parameter learning device 10 includes a learning data storage unit 11 and a model parameter learning unit 12.

The learning data storage unit 11 stores the collected learning data with attribute labels. The collected learning data with attribute labels is a set of three elements of an acoustic feature quantity sequence Xₙ, a phoneme sequence Sₙ, and an attribute label a. When the number of elements is N (1≤n≤N, for example, N=10000), the learning data with attribute labels is represented by the following expression. Tₙ is the length of the acoustic feature quantity sequence Xₙ or the phoneme sequence Sₙ and has a different value depending on n. An acoustic feature quantity includes an arbitrary quantity such as, for example, a mel-frequency cepstral coefficient (MFCC), a conversion thereof such as normalization, or a combination of a plurality of feature quantities before and after in time. An attribute label includes an arbitrary label such as, for example, information indicating either male or female or information indicating whether either Japanese or foreigner.

[Formula 1]

Learning data with attribute labels: (X₁,S₁,a₁), . . . ,(X_{N},S_{N},a_{N}) (1)

Here, Xₙ=(x₁ₙ, . . . , x_{T}_{ₙ}ₙ), Sₙ=(s₁ₙ, . . . , s_{T}_{ₙ}ₙ)

The model parameter learning unit 12 acquires the collected learning data with attribute labels recorded in the learning data storage unit 11, learns model parameter groups θ₁, θ₂, and θ₃ of three models included in the learning data generation device 20, and outputs the model parameter groups to the learning data generation device 20. Learning is performed on the basis of the criteria illustrated in the following expression. Although learning is performed differently depending on the definitions of respective probability distributions, the learning can be performed on the basis of maximum likelihood criteria as below in any case. In this case, θ with the symbol \hat{ } means θ (estimated on the basis of maximum likelihood criteria by the right side) satisfying the right side.

$$\begin{matrix}[ Formula 2 ] & \\ {\hat{θ}}_{1} = {argmax}_{{0}_{1}} {\prod }_{n = 1}^{N} P ( {a}_{n} \vert {θ}_{1} ) \\ {\hat{θ}}_{2} = {argmax}_{{0}_{2}} {\prod }_{n = 1}^{N} {\prod }_{t = 1}^{{T}_{n}} P ( {s}_{t n} \vert {s}_{1 n} , … , {s}_{t - 1 n} , {a}_{n} , {θ}_{2} ) \\ {\hat{θ}}_{3} = {argmax}_{{0}_{3}} {\prod }_{n = 1}^{N} {\prod }_{t = 1}^{{T}_{n}} P ( {x}_{t n} \vert {s}_{1 n} , … , {s}_{{T}_{n} n} , {a}_{n} , {θ}_{3} ) & ( 2 )\end{matrix}$$

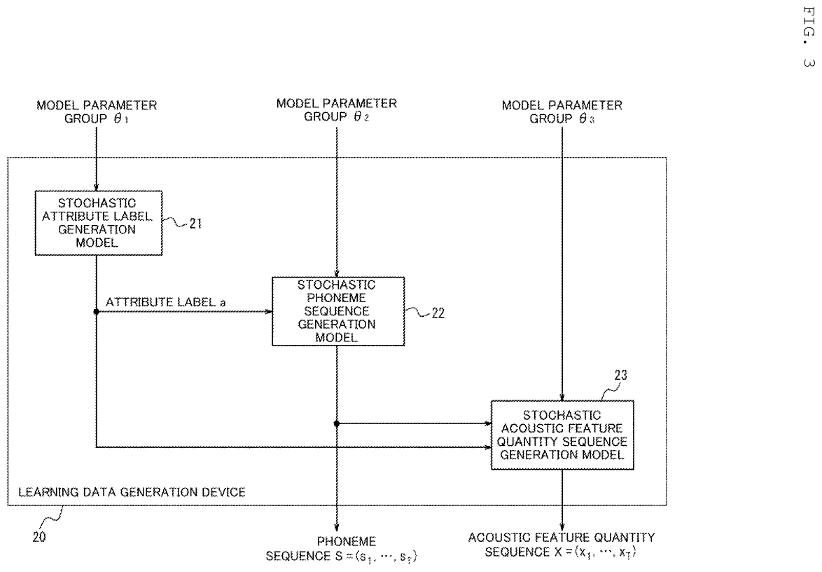

FIG. 3 is a diagram illustrating a configuration example of the learning data generation device 20. The learning data generation device 20 is a device that generates acoustic model learning data and includes a stochastic attribute label generation model 21 that determines attribute labels stochastically, a stochastic phoneme sequence generation model 22 that determines a phoneme sequence from the attribute labels stochastically, and a stochastic acoustic feature quantity sequence generation model 23 that generates an acoustic feature quantity sequence from the attribute labels and the phoneme sequence stochastically.

The learning data generation device 20 receives the model parameter groups θ₁, θ₂, and θ₃ of the three models included in the learning data generation device 20 and generates and outputs an acoustic feature quantity sequence X=(x₁, . . . , x_{T}) and a phoneme sequence S=(s₁, . . . , s_{T}) as pseudo learning data. T represents a frame length of the acoustic feature quantity sequence X and the phoneme sequence S. The frame length T may be manually determined in advance as a prescribed value (for example, 100) and may be automatically determined during the generation of the phoneme sequence S. When T is determined automatically, the timing at which a specific phoneme is generated may be determined as T, and for example, the frame length T may be allocated to the timing of a phoneme corresponding to silence.

The stochastic attribute label generation model 21 generates an attribute label “a” related to the desired speech to be generated by stochastic operations according to a first probability distribution from the model parameter group θ₁. The generated attribute label “a” is output to the stochastic phoneme sequence generation model 22 and the stochastic acoustic feature quantity sequence generation model 23. Specifically, the stochastic attribute label generation model 21 determines one attribute label “a” randomly from the first probability distribution according to the following expression.

[Formula 3]

a˜P(a|θ₁) (3)

A categorical distribution, for example, can be used as the first probability distribution. In this case, the entity of the model parameter group θ₁ is a model parameter of a categorical distribution for the attribute label a. The symbol “˜” means that the attribute is generated randomly according to a probability distribution. This random generation follows a SampleOne algorithm as below, for example. The SampleOne algorithm is a known method in random sampling from a categorical distribution.

The SampleOne algorithm is an algorithm that determines one value randomly from a probability distribution and receives a categorical distribution and outputs an observed value of the probability distribution. As a specific example, a case in which P(a|θ₁) is input which is the above-described example will be considered. P(a|θ₁) has a form of a probability distribution called a categorical distribution. When a set of specific observed values of the attribute label “a” is J and the number of types of observed values included in J is |J|, the values that the attribute label “a” can take are t₁, t₂, . . . , t_{|J|}. That is, t₁, t₂, . . . , t_{|J|} are specific observed values and a set thereof is J. J is determined automatically when model parameters of a probability distribution are given. Specifically, the probability distribution is P(a=t₁|θ₁), P(a=t₂|θ₁), . . . , P(a=t_{|J|}|θ₁). In this case, P(a) has the following properties.

$$\begin{matrix}[ Formula 4 ] & \\ {\sum }_{a ∈ j} P ( a \vert {0}_{1} ) = 1 & ( 4 )\end{matrix}$$

In this case, SampleOne of the attribute label “a” is based on random numbers. Random numbers are defined as rand. P(a=t₁|θ₁), P(a=t₂|θ₁), . . . , P(a=t_{|J|}|θ₁) have specific values. Values are calculated sequentially in order of rand−P(a=t₁|θ₁), rand−P(a=t₁|θ₁)−P(a=t₂|θ₁), and rand−P(a=t₁|θ₁)−P(a=t₂|θ₁)−P(a=t₃|θ₁), and a value when the value becomes smaller than 0 is output. For example, t₂ is output when the following expression is satisfied. In this manner, the SampleOne algorithm can be said to be a data sample algorithm from an arbitrary categorical distribution.

[Formula 5]

rand−P(a=t₁|θ₁)>0

rand−P(a=t₁|θ₁)−P(a=t₂|θ₁)<0 (5)

The stochastic phoneme sequence generation model 22 generates a phoneme sequence S=(s1, . . . , s_{T}) related to the desired speech to be generated by stochastic operations according to a second probability distribution from the model parameter group θ₂ and the attribute label “a” generated by the stochastic attribute label generation model 21. The generated phoneme sequence S is output to the stochastic acoustic feature quantity sequence generation model 23 and is also output to the outside of the learning data generation device 20.

The phoneme sequence S is generated for respective phonemes. A distribution (for example, a categorical distribution) that defines P(sₜ|s₁, . . . , sₜ₋₁, a, θ₂) can be used as the second probability distribution. Although P(sₜ|s₁, . . . , sₜ₋₁, a, θ₂) may use an arbitrary structure, it can be defined using an n-gram model or a recurrent neural network, for example. Although the model parameter group θ₂ is different depending on a defined model, the model parameter group is model parameters capable of defining a categorical distribution for sₜ using s₁, . . . , sₜ₋₁, a. Generation of the phoneme sₜ follows the following expression.

[Formula 6]

s₁˜P(s₁, . . . ,sₜ₋₁,a,θ₂) (6)

This random generation follows the above-described SampleOne algorithm. This processing can be performed recursively and generation of a phoneme sₜ₊₁ follows the following expression using the generated phoneme sₜ.

[Formula 7]

sₜ₊₁˜P(sₜ₋₁|s₁, . . . ,sₜ,a,θ₂) (7)

By performing this processing T times, it is possible to generate the phoneme sequence S (s1, . . . , s_{T}). T may be determined manually. When T is determined automatically, the time when a phoneme (for example, a phoneme representing silence) defined in advance may be determined as T.

The stochastic acoustic feature quantity sequence generation model 23 generates an acoustic feature quantity sequence X=(x₁, . . . , x_{T}) related to the desired speech to be generated by stochastic operations according to a third probability distribution from the model parameter group θ₃, the attribute label “a” generated by the stochastic attribute label generation model 21, and the phoneme sequence S=(s₁, . . . , sₜ) generated by the stochastic phoneme sequence generation model 22. The generated acoustic feature quantity sequence X is output to the outside of the learning data generation device 20.

The acoustic feature quantity sequence X is generated for respective acoustic feature quantities. An arbitrary continuous spatial probability distribution that defines P(xₜ|s₁, . . . , sₜ, a, θ₃) can be used as the third probability distribution, and for example, a normal distribution is used. When a normal distribution is used, it is sufficient that a mean vector and a covariance matrix which are parameters of a normal distribution are obtained from s₁, . . . , , s_{T}, a, θ₃, and for example, Mixture Density Network as illustrated in Non-Reference Document 4 is used. The model parameter group θ₃ corresponds to model parameters obtained by calculating parameters of a defined distribution from s₁, . . . , s_{T}, a, θ₃. Generation of the acoustic feature quantity xₜ follows the following expression.

[Formula 8]

xₜ˜P(xₜ|s₁, . . . ,s_{T},a,θ₃) (8)

Although the random generation is different depending on a defined probability distribution, for example, in the case of a normal distribution having a diagonal covariance matrix, values can be generated using a Box-Muller's method for each dimension. Since the Box-Muller's method is a known technique, the description thereof will be omitted. This processing is performed from t=1 to T whereby the acoustic feature quantity sequence X=(x₁, . . . , x_{T}) can be obtained. It is assumed that T matches the length of an input phoneme sequence.

A computer may be used to function as the learning data generation device 20. Such a computer can be realized by storing a program describing the details of processing realizing the functions of the learning data generation device 20 in a storage unit of the computer and allowing a CPU of the computer to read and execute the program.

The program may be recorded on a computer-readable medium. The use of the computer-readable medium enables the program to be installed on the computer. In this case, the computer-readable medium having the program recorded thereon may be a non-transitory recording medium. Although the non-transitory recording medium is not particularly limited, a recording medium such as CD-ROM or DVD-ROM may be used, for example.

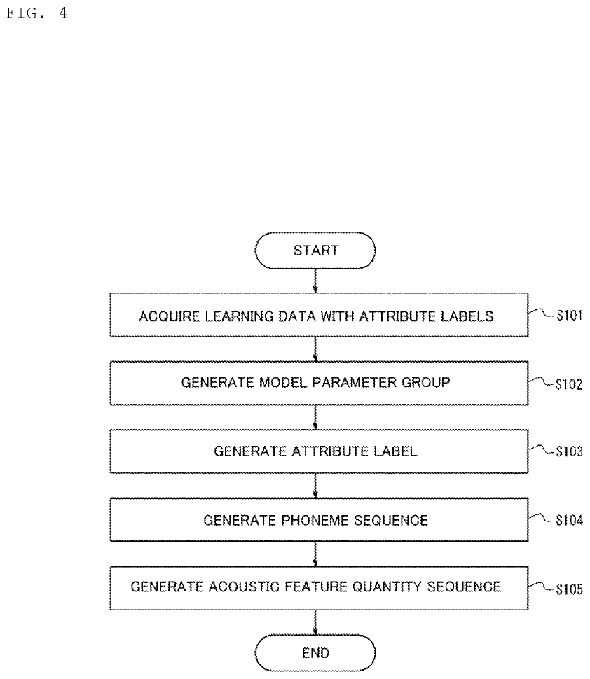

Next, a learning data generation method according to an embodiment of the present invention will be described with reference to FIG. 4. FIG. 4 is a flowchart illustrating an example of procedures of the learning data generation method.

First, the model parameter learning unit 12 acquires learning data with attribute labels (step S101) and generates three model parameter groups θ₁, θ₂, and θ₃ (step S102). Subsequently, the stochastic attribute label generation model 21 generates attribute labels “a” according to a first probability distribution from the model parameter group θ₁ (step S103). Subsequently, the stochastic phoneme sequence generation model 22 generates a phoneme sequence S according to a second probability distribution from the model parameter group θ₂ and the attribute labels “a” as the learning data (step S104). Subsequently, the stochastic acoustic feature quantity sequence generation model 23 generates an acoustic feature quantity sequence X according to a third probability distribution from the model parameter group θ₃, the attribute labels a, and the phoneme sequence S as the learning data (step S105).

As described above, in the present invention, the attribute labels “a” are generated according to the first probability distribution from the model parameter group θ₁, the phoneme sequence is generated according to the second probability distribution from the model parameter group θ₂ and the attribute labels a, and the acoustic feature quantity sequence X is generated according to the third probability distribution from the model parameter group θ₃, the attribute labels a, and the phoneme sequence S. Therefore, according to the present invention, it is possible to pseudo-generate the acoustic model learning data (the phoneme sequence S and the acoustic feature quantity sequence X) with stochastic actions only without manually applying speech variation rules.

The conventional method of pseudo-generating acoustic model learning data creates an acoustic feature quantity sequence to which acoustic variation factors are pseudo-added according to rules manually modelled in advance to the acoustic feature quantity sequence of the collected learning data and makes a pair with a corresponding phoneme sequence. Therefore, in this method, it is not possible to generate learning data for a phoneme sequence that is not present in the collected learning data. In this respect, in the present invention, the model parameter groups θ₁, θ₂, and θ₃ are generated on the basis of maximum likelihood criteria from the collected learning data with attribute labels (attribute labels, the phoneme sequence, and the acoustic feature quantity sequence), respectively. Therefore, according to the present invention, it is possible to generate learning data (a phoneme sequence and an acoustic feature quantity sequence) that is not present in the collected learning data with attribute labels. Therefore, it is possible to construct an acoustic model with a high speech recognition performance.

In this case, the first and second probability distributions are preferably a categorical distribution. This is because a categorical distribution is generally used as a distribution that models the generation of discrete values, and parameters of the categorical distribution can be output, for example, by a method which uses a neural network in which a softmax layer is an output. Moreover, the third probability distribution is preferably a normal distribution. This is because a normal distribution is generally used as a distribution that models the generation of continuous values, and parameters of the normal distribution can be output, for example, by a method which uses a neural network in which a mean and a variance are the output.

While the above-described embodiment has been described as a representative example, it is obvious to those skilled in the art that many changes and substitutes can be made within the spirit and the scope of the present invention. Therefore, the present invention is not construed to be limited by the above-described embodiment, and various modifications and changes can occur without departing from the scope of the claims. For example, a plurality of constituent blocks illustrated in the schematic diagrams of the embodiment may be combined as one block, and one constituent block may be divided into a plurality of blocks.

### REFERENCE SIGNS LIST

1 Learning data generation system
10 Model parameter learning device
11 Learning data storage unit
12 Model parameter learning unit
20 Learning data generation device
21 Stochastic attribute label generation model
22 Stochastic phoneme sequence generation model
23 Stochastic acoustic feature quantity sequence generation model

1. A learning data generation device that generates acoustic model learning data, comprising: a stochastic attribute label generation model that generates attribute labels from a first model parameter group according to a first probability distribution; a stochastic phoneme sequence generation model that generates a phoneme sequence from a second model parameter group and the attribute labels according to a second probability distribution; and a stochastic acoustic feature quantity sequence generation model that generates an acoustic feature quantity sequence from a third model parameter group, the attribute labels, and the phoneme sequence according to a third probability distribution.

2. The learning data generation device according to claim 1, wherein the first, second, and third model parameter groups are generated on the basis of maximum likelihood criteria from the collected attribute labels, the phoneme sequence, and the acoustic feature quantity sequence.

3. The learning data generation device according to claim 1, wherein the stochastic attribute label generation model generates the attribute labels using an algorithm that determines one value randomly from the first probability distribution, the stochastic phoneme sequence generation model generates the phoneme sequence using an algorithm that determines one value randomly from the second probability distribution, and the stochastic acoustic feature quantity sequence generation model generates the acoustic feature quantity sequence using an algorithm that determines one value randomly from the third probability distribution.

4. The learning data generation device according to claim 1, wherein the first and second probability distributions are a categorical distribution, and the third probability distribution is a normal distribution.

5. A learning data generation method of generating acoustic model learning data, comprising: generating attribute labels from a first model parameter group according to a first probability distribution; generating a phoneme sequence from a second model parameter group and the attribute labels according to a second probability distribution; and generating an acoustic feature quantity sequence from a third model parameter group, the attribute labels, and the phoneme sequence according to a third probability distribution.

6. A program for causing a computer to function as the learning data generation device according to claim 1.
